(19) United States
(12) Patent Application Publication
(10) Pub. No.: US 2023/0337562 A1
(43) Pub. Date: Oct. 26, 2023

(54) WEED CUTTING AND REMOVAL APPARATUS

(71) Applicant: Burz, LLC, Colorado City, AZ (US)

(72) Inventor: Stacy Stubbs, Colorado City, AZ (US)

(73) Assignee: Burz, LLC, Colorado City, AZ (US)

(21) Appl. No.: 18/304,239

(22) Filed: Apr. 20, 2023

Related U.S. Application Data
(60) Provisional application No. 63/333,466, filed on Apr. 21, 2022.
(60) Provisional application No. 63/374,937, filed on Sep. 8, 2022.

(51) Int. Cl. A01B 1/18

(52) U.S. Cl. CPC A01B 1/18

(57) ABSTRACT

A weed cutting apparatus includes a handle coupled to a head at a distal end. The head has a first end and a second end, wherein the first end is proximal to the handle and the second end is distal thereto. The second end is formed and sharpened to form a blade with a plurality of tines extending from the blade. Alternatively, a bladed member may be an aftermarket attachment coupled via channels to a medial end of a plurality of tines on a pitchfork. As a result, any weed or object that passes through the plurality of tines is cut by the blade. In some examples, the first end of the head may have other working features, such as grooves or apertures for uprooting the roots of a severed weed.

### CROSS-REFERENCE TO RELATED APPLICATIONS

This application claims the benefit of U.S. Provisional Application Ser. No. 63/333,466, filed on Apr. 21, 2022, and U.S. Provisional Application Ser. No. 63/374,937, filed on Sep. 8, 2022, both of which are incorporated herein by reference.

### TECHNICAL FIELD

The present disclosure relates to tools for weed removal. More particularly, the present disclosure relates to a handheld tool and attachment for cutting and removing weeds.

### BACKGROUND

Weeds are any unwanted plants within lawns, gardens, and other landscapes. Oftentimes, weeds disrupt the growth of surrounding plants and produce irritants such as thorns and burrs. While some weeds may be pulled by hand, others require a handheld implement or tool to remove. A tool may be needed, for example, when the weed has thorns that can puncture a user's gloves. In particular, Tribulus terrestris (also known as “goathead weeds”) contain many thorns making removal impractical by hand. In addition, the weed may be horizontally displaced, which may make it difficult to find and grab the base of the weed. Even if the base is found, it may be too strong to remove by hand. Other weeds may also make it difficult to reach the base, either due to size, thorns, or other issues. As a result, a user may use a tool found in the prior art, such as a draw or scuffle hoe. However, use of these tools results in the weed being cut into several pieces, which not only makes cleanup a hassle, but spreads seeds into the ground, causing additional weeds to grow.

Many currents methods of removing goathead weeds are similarly inefficient. Some of these methods include burning the weeds with propane, spraying to inhibit new growth, or using various approaches to collect thorns. When using any approach to remove the goathead weeds, there still remains the issue of the thorny seeds that have been dispersed on the ground. Spray and burning may kill the weed, but may not kill all the seeds, which can lead to future growth of the goathead weed. Typically, by the time goathead weed growth is readdressed after burning or spraying, there are more dried-out thorny seeds on the ground. To prevent future goathead weed growth, it is essential that seeds are not dispersed in the first place and that any dried-out thorny seeds are collected and discarded.

Accordingly, there is a need for a tool that is capable of cutting and removing weeds at their base, regardless of the vertical or horizontal spread of the weed, and that maintains the weed as a single unit, limiting the spread of thorny seeds and making cleanup easier. The tool should further feature an ergonomic design that reduces physical exertion and fatigue of a user. The present disclosure solves these problems and others.

### SUMMARY OF EXAMPLE EMBODIMENTS

In some embodiments, a weed cutting apparatus comprises a handle with a head at a distal end. The head comprises a first end and a second end, wherein the first end is proximal to the handle and the second end is distal thereto. The second end may comprise a blade and a plurality of tines extending from the blade, opposite the handle. As a result, any weed or object that passes through the tines is cut by the blade on the second end of the head.

In some embodiments, a weed cutting apparatus comprises a bladed member having one or more channels configured to receive one or more of a plurality of tines, the bladed member couplable to a pitchfork. The bladed member may be an aftermarket attachment that enables periodic maintenance and sharpening of the blade between uses and that is couplable to a user's pre-purchased pitchfork.

In some embodiments, the first end of the head comprises other working features, such as grooves or protrusions for uprooting the roots of a severed weed. The grooves may be substantially triangular in shape or otherwise tapered to receive a root of the weed within a mouth having a first length that is wider than a body having a second length. A user may thereby wedge a stem of the weed therein and then maneuver the handle as a lever to uproot the stem and roots.

### BRIEF DESCRIPTION OF THE DRAWINGS

FIG. 1 illustrates a front elevation view of a weed cutting apparatus;

FIG. 2 illustrates a right, side elevation view of a weed cutting apparatus, the left side being a mirror image thereof;

FIG. 3 illustrates a front, right side perspective view of a weed cutting apparatus;

FIG. 4 illustrates a front, detailed view of a distal end of a weed cutting apparatus;

FIG. 5 illustrates a front, detailed view of a distal end of a weed cutting apparatus;

FIG. 6 illustrates a front, side perspective view of a bladed member of a weed cutting apparatus;

FIG. 7 is a top, rear perspective view of a bladed member of a weed cutting apparatus; and

FIG. 8 is a bottom, front perspective view of a bladed member of a weed cutting apparatus.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation. Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,” etc.).

As previously discussed, there is a need for a tool that is capable of cutting and removing weeds at their base, regardless of the vertical or horizontal spread of the weed, and that maintains the weed as a single unit, limiting spread and making cleanup easier. The weed cutting apparatus disclosed herein solves these problems and others.

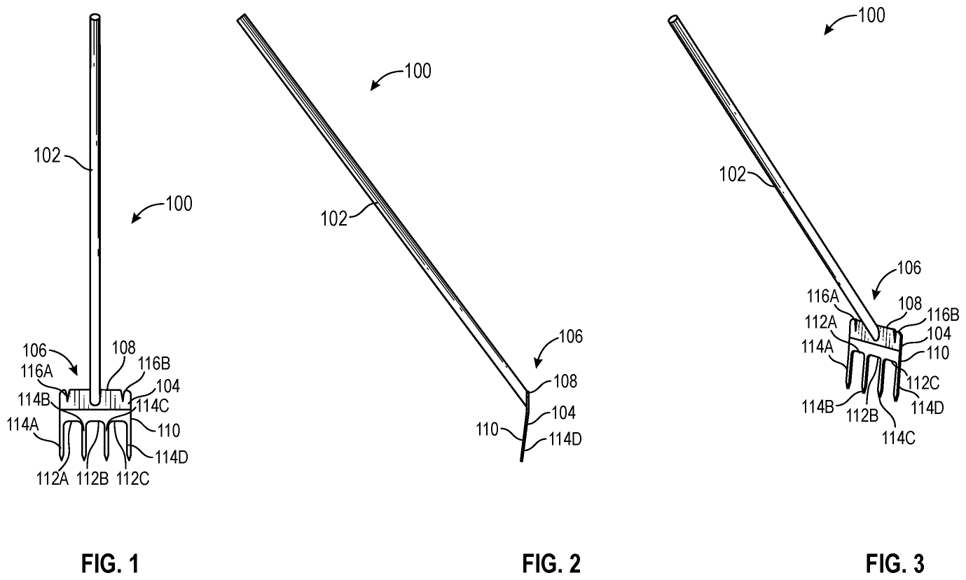

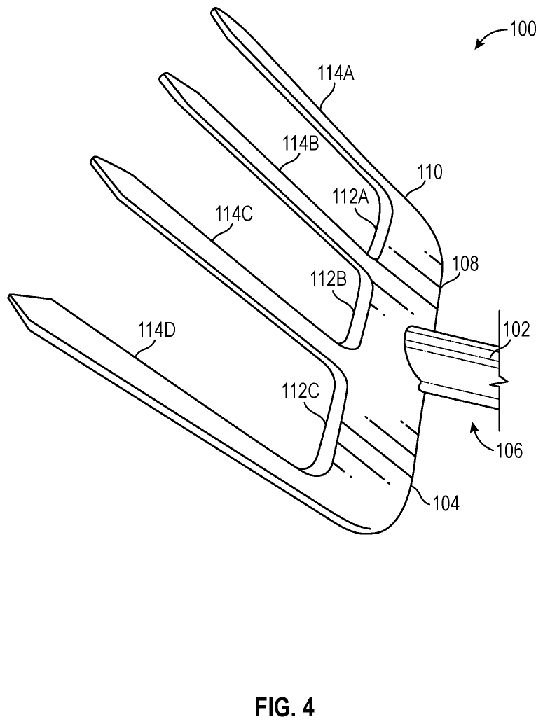

Referring to FIGS. 1-4, in some embodiments, a weed cutting apparatus 100 comprises a handle 102 coupled to a head 104 at a distal end 106. The handle 102 may be a shortened or an elongated pole manufactured from wood, metal, plastic, or combinations thereof, and may have an ergonomic grip. The handle 102 may be welded to, screwed on, or otherwise fastened to the head 104 by alternative mechanical fasteners at an angle, without limitation, ranging between 15 and 75 degrees, but in a preferred embodiment at 45 degrees.

The head 104 comprises a first end 108 and a second end 110, wherein the first end 108 is proximal to the handle 102 and the second end 110 is distal thereto. The second end 110 may comprise a blade 112A-C and a plurality of tines 114A-D extending from the blade 112A-C, opposite the handle 102. The blade 112A-C, without limitation, may be a straight back blade having a curving edge and a straight spine. It will be appreciated that a straight back blade is optimized for thrusting, as the curving edge, in practice, cuts a swath of the weeds that an entire width of the blade 112A-C can pass through without the straight spine having to push aside any material along its path. The blade 112A-C, in some embodiments, may comprise separate sections or areas between the plurality of tines 114A-D. The blade 112A-C, in other embodiments, may comprise a single area that extends across the plurality of tines 114A-D. As a result, any plant or object that passes between the tines 114A-D is cut by the blade 112A-C on the second end 110 of the head 104.

The plurality of tines 114A-D may be coupled at an angle, without limitation, between 0 and 30 degrees, relative to the first end 108. The angle enables the plurality of tines 114A-D to easily skim over a surface of the ground with minimal resistance to a user during a forward thrust and creates a gradient that moves the weed from the plurality of tines 114A-D back towards a flat portion of the head 104 in preparation for disposal. The angle further prevents the plurality of tines 114A-D from disrupting the soil and distributing seeds from the weed into the soil.

In some embodiments, as shown, a body of each of the plurality of tines 114A-D may be straight, flat, and wide in order to also help minimize disruption of the soil during use, as compared to traditional curved tines on pitchforks, as well as create an area on which the weed may be collected after being cut. A tip of the plurality of tines 112A-D may be pointed to push aside and penetrate a growth (e.g., leaves and branches) of the weed and expose the stem of the weed to the blade 112A-C.

In some embodiments, as best seen in FIGS. 1-3, the first end 108 of the head 104 may comprise other working features, such as grooves 116A-B or other apertures, configured to uproot the roots of a severed weed. The grooves 116A-B, as shown, may be substantially triangular in shape or otherwise tapered to receive the root of the weed within a mouth having a first width that is wider than a body having a second width. The narrower body of the grooves 116A-B may be textured or comprise a coarse surface for engaging the root of the weed and pulling it out of the ground.

In some embodiments, a method of using a weed cutting apparatus 100 comprises a user holding a handle 102, placing a plurality of tines 114A-D substantially parallel to the ground, sliding the plurality of tines 114A-D beneath a growth of a weed until a blade 112A-C engages a stem of the weed, and cutting the stem of the weed with the blade 112A-C. Once severed, the method may further comprise lifting the weed, now resting on a head 104 of the weed cutting apparatus 100, and discarding it in a bin, bag, or however preferred by a user. In this way, it will be appreciated that minimal seeds are spread across the ground, and the user need not bend over to pull the weed out or collect it for disposal. Moreover, because the user does not need to grab the weed, there is no risk of perforation to the user by a thorn. With at least the stem and growth of the weed removed, a user may then apply a weed killer or other herbicide to the roots. Additionally, or in the alternative, a user may use the grooves 116A-B on the first end 108 of the head 104 to wedge the stem of the weed therein and then maneuver the handle 102 as a lever to uproot the stem and roots. As a result, the entire weed may be removed from unwanted areas.

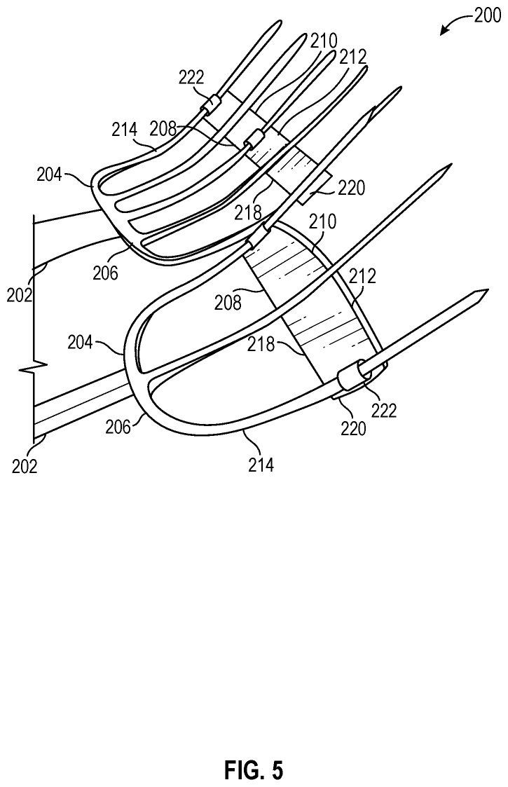

In some embodiments, as shown in FIG. 5, a weed cutting apparatus 200 (two examples shown) comprises a handle 202 with a head 204 at a distal end 206, a plurality of tines 214 extending from the head 204, and a bladed member 218 couplable to the plurality of tines 214 at a medial end 220—although it will be appreciated that positions other than medial are contemplated herein as well and such modifications do not depart herefrom. The bladed member 218 comprises a first end 208 and a second end 210, wherein the first end 208 is proximal to the handle 202 and the second end 210 is distal thereto.

The bladed member 218 may further comprise one or more channels 222 configured to receive one or more of the plurality of tines 214, respectively. The second end 210 is formed and sharpened to form a blade 212. In some embodiments, the bladed member 218 may be couplable to the plurality of tines 214, such that the blade 212 of the bladed member 218 is between the plurality of tines 214 and the ground during use. As a result, any plant or object that passes between the plurality of tines 214 is cut by the blade 212 on the second end 210 of the bladed member 218. While FIG. 5 depicts two weed cutting apparatuses 200 with three tines and five tines respectively, it will be understood to those skilled in the art that more or less tines may be included within the plurality of tines 214.

It will be appreciated that a position of the bladed member 218 at a medial end 220 of the weed cutting apparatus 200 permits more leveraged strength exerted by a user to be directed towards cutting weeds at a tip of the blade 212. The blade 212 may have either a straight or rounded edge. The bladed member 218 may comprise steel, titanium alloys, ceramics, plastics, or related metals and materials sufficient for forming a blade 212.

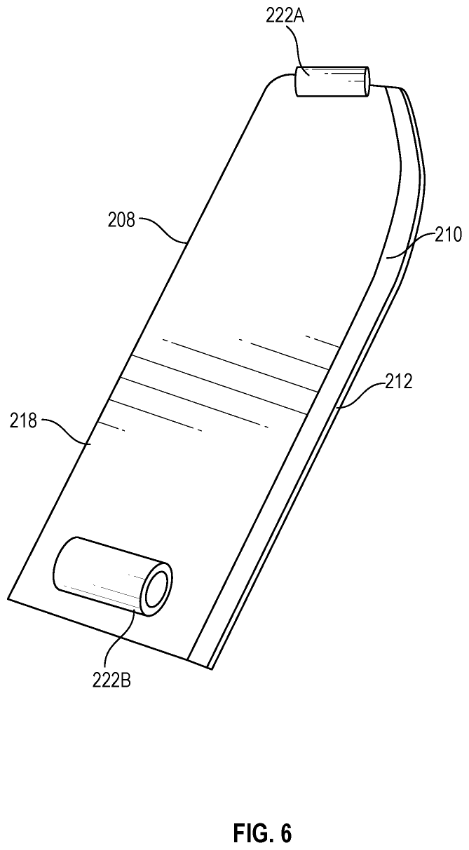

FIGS. 6-8 illustrate various perspective views of the bladed member 218. It will be appreciated that the bladed member 218 may be permanently affixed to the plurality of tines 214 of the weed cutting apparatus 200 at the time of manufacture or may be an aftermarket attachment that is detachably couplable via the one or more channels 222A-B to the plurality of tines 214, wherein the one or more channels 222A-B are configured to be distanced apart and angled corresponding to a distance and angle of a plurality of tines as sold on common pitchfork and garden fork models. A width of the one or more channels 222A-B may be configured to be coupled by compression fit to a width of the plurality of tines 214 at the medial end 220, or may use other techniques for securing the bladed member 218 to the tines, such as by using locking screws, bolts, etc.

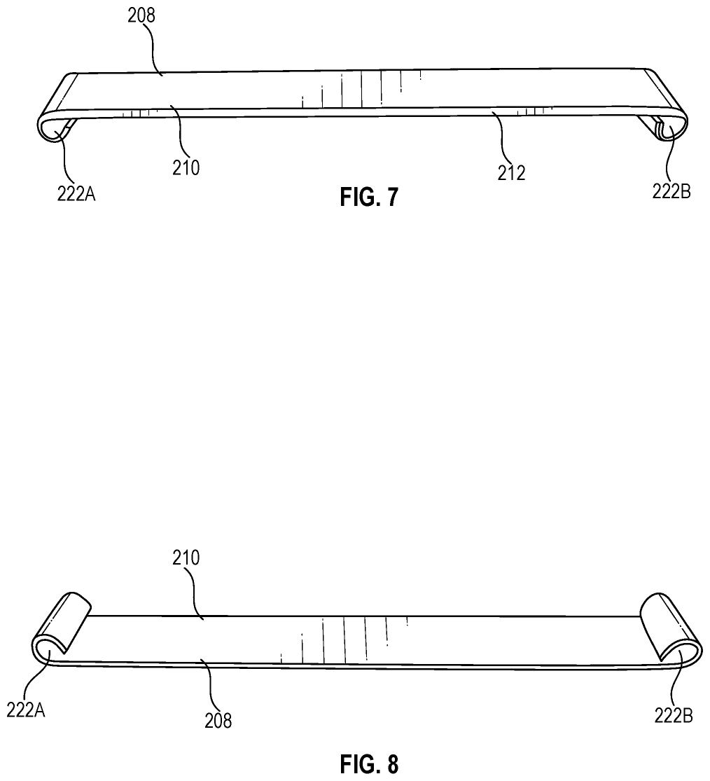

As seen in FIGS. 7-8, the plurality of channels 222A-B may be formed by bending sides of the bladed member 218 inwards, towards a center of the bladed member 218, forming a channel sized complementary to the tines of a pitchfork. It will be appreciated that as an aftermarket attachment, the bladed member 218 may be readily removed facilitating periodic maintenance and sharpening of the blade 212. The detachable nature of the bladed member 218 also permits the use of the pitchfork for standard applications and the easy conversion of the pitchfork into a weed cutting apparatus 200 when removing weeds. While not shown in these figures, it will be appreciated that the bladed member 218 may also comprise grooves or other apertures on a second end 210 for uprooting roots, as discussed earlier herein (e.g., 116A-B).

Therefore, it will be appreciated from the foregoing that the weed cutting apparatus 100, 200 disclosed herein solves the need for a tool that is capable of cutting and removing weeds at their base, regardless of the vertical or horizontal spread of the weed, and that maintains the weed as a single unit, limiting spread and making cleanup easier.

It will be appreciated that systems and methods according to certain embodiments of the present disclosure may include, incorporate, or otherwise comprise properties or features (e.g., components, bladed members, elements, parts, and/or portions) described in other embodiments. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, bladed members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A weed cutting apparatus, comprising:
a handle;
a head coupled to a distal end of the handle, the head comprising;
a first end proximal to the handle,
a second end distal to the handle and comprising a plurality of tines and a blade, wherein the blade extends between the plurality of tines.

2. The weed cutting apparatus of claim 1, wherein the first end of the head comprises grooves configured to uproot roots of a severed weed.

3. The weed cutting apparatus of claim 1, wherein the blade is a straight back blade having a curving edge and a straight spine.

4. The weed cutting apparatus of claim 1, wherein the head is coupled to the handle at an angle between 15 and 75 degrees.

5. The weed cutting apparatus of claim 1, wherein the blade further extends across each tine of the plurality of tines.

6. The weed cutting apparatus of claim 1, wherein the plurality of tines and the head of the weed cutting apparatus comprise a flat surface.

7. The weed cutting apparatus of claim 1, wherein the plurality of tines is coupled to the head at an angle between 0 and 30 degrees, configured to prevent the plurality of tines from disrupting soil and distributing seeds during use.

8. A weed cutting member, comprising:
a handle;
a head coupled to a distal end of the handle, the head comprising a plurality of tines;
a bladed member couplable to the plurality of tines, the bladed member comprising;
a first end, proximal to the handle;
one or more channels configured to receive one or more of the plurality of tines, and
a blade, distal to the handle.

9. The weed cutting apparatus of claim 8, wherein the first end of the bladed member comprises grooves or protrusions configured to uproot roots of a severed weed.

10. The weed cutting apparatus of claim 8, wherein the blade is a straight back blade having a curving edge and a straight spine.

11. The weed cutting apparatus of claim 8, wherein the one or more channels are formed by bending sides of the bladed member inwards towards a center of the bladed member.

12. The weed cutting apparatus of claim 8, wherein the one or more channels are cylindrical in shape and welded to a front of the bladed member.

13. The weed cutting apparatus of claim 8, wherein the bladed member is couplable to the plurality of tines, such that the blade of the bladed member is positioned between the plurality of tines and the ground during use.

14. A method of using a weed cutting apparatus, the method comprising:
holding a handle;
placing a plurality of tines substantially parallel to the ground;
sliding the plurality of tines beneath a growth of a weed; and
cutting a stem of the weed with a blade between the plurality of tines.

15. The method of claim 14, further comprising engaging grooves on the weed cutting apparatus with either the root or a stem of the weed and maneuvering the handle as a lever to uproot the root and the stem from the ground.

16. The method of claim 15, further comprising collecting the weed on a head of the weed cutting apparatus and disposing of the weed.

17. The method of claim 14, wherein the blade is coupled to the tines via a plurality of channels and comprises engaging each of the plurality of channels with a respective tine of the plurality of tines, prior to cutting the stem of the weed.
